(19) United States
(12) Patent Application Publication
(10) Pub. No.: US 2008/0044724 A1
(43) Pub. Date: Feb. 21, 2008

(54) Sealed secondary battery having bottomed tubular casing, closure plate fixed to opening of the casing, and valve plate closing hole formed through the closure plate

(75) Inventors: Hiroyuki Inoue, Osaka (JP); Masahiro Hosoda, Osaka (JP); Takaaki Aoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 11/729,975

(22) Filed: Mar. 30, 2007

(30) Foreign Application Priority Data
Mar. 31, 2006 (JP) 2006-099337

(51) Int. Cl. H01M 2/02; H01M 10/02; H01M 2/14

(52) U.S. Cl. 429/129

(57) ABSTRACT

The aim is to provide a sealed secondary battery with an electrode body that is larger in volume and thus incapacity, without affecting the operability of a valve member and the battery hermeticity. To achieve the aim, the sealed secondary battery includes an electrode body, an external casing, a closure plate, and a valve member. The external casing is of a tubular shape having a bottom and an opening. The closure plate has a hole formed through a central portion thereof and is secured at a peripheral portion to the edge of the opening of the external casing. The valve member has a resilient portion and a plate portion. The plate portion is biased by the resilient portion against the closure plate to close off the hole. The closure plate is smaller in average thickness at portions opposite a main surface of the plate portion than at other portions.

### BACKGROUND OF THE INVENTION

(1) Field of the Invention

The present invention relates to a sealed secondary battery having: an external casing of a bottomed tubular shape; a closure plate that has a hole formed therethrough and is fixed to an opening of the external casing; and a valve plate closing the hole. More particularly, the present invention relates to a structure of the closure plate.

(2) Description of the Related Art

The following describes a conventional closure assembly used in a sealed secondary battery with reference to FIG. 1. As illustrated in FIG. 1, a closure assembly 80 includes a cap 81 having a shape of a shallow dish and a closure plate 82 having a recessed central portion. The cap 81 and the closure plate 82 are joined together so as to leave an enclosed space 87 therebetween. The cap 81 has a hole 85 formed therethrough. Similarly, the closure plate 82 has a hole 86 formed therethrough. The space 87 accommodates a valve member 88 (gas release mechanism) therein. The valve member 88 is composed of a spring 83 and a valve plate 84. The closure assembly 80 is sealed to an opening of an external casing 89 that accommodates an electrode body 90 therein. This is how a sealed secondary battery is structured.

A passage for releasing gas is formed via the two holes 85 and 86. Under the steady state in which the internal pressure of the battery falls within a predetermined range, the gas passage is blocked as a result that the valve plate 84 is held against the hole 86. If the internal pressure increases beyond the predetermined range, the gas passage is brought into open communication as a result that the valve plate 84 is pressed back to compress the spring 83 (See JP Patent Application Publication No. 2001-283809).

### SUMMARY OF THE INVENTION

Through the years, it has been demanded to further improve the energy density of sealed secondary batteries. To meet the demand, the inventors of the present invention have studied a technique of reducing the thickness of a closure assembly in order to allow an increase of an electrode body in volume without affecting the battery's outer dimensions.

As illustrated in FIG. 1, the thickness of the closure assembly 80 is largest at the central portion where the valve member 88 is accommodated. In order to make the closure assembly thinner, it is necessary to reduce Thickness t7 of the central portion.

The closure assembly may be reduced in central portion thickness by reducing Height t1 of the space 87 accommodating the valve member 88 or alternatively by reducing the thickness of the closure plate 82.

However, if the height of the space 87, more specifically, Distance t1 between the cap 81 and the valve plate 84 is reduced in the direction axially of the spring 83, the following problem arises. That is, since the stroke of the spring 83 shortens with Distance t1, the valve member 88 responds less reliably to an increase in internal pressure of the battery. As a result, deformation of the closure assembly 80 is more likely. This raises the risk of the closure assembly 80 being detached or disengaged from the opening of the external casing and thus affecting the hermeticity of the battery.

Yet, if the thickness of the closure plate 82 is reduced, the closure assembly 80 tends to deform more easily when applied with force resulting from an increased internal pressure of the battery. As a result, the risk of affecting the hermeticity of the battery increases.

The present invention is made in view of the above problems and aims to provide a sealed secondary battery with an electrode body that is increased in volume and thus in capacity, without affecting the operability of a valve member and the hermeticity of the battery.

In order to achieve the above aim, the sealed battery according to the present invention has the following components (1)-(4):

(1) an electrode body having a positive plate, a negative plate, and a separator;

(2) an external casing of a tubular shape having a bottom and an opening, the external casing accommodating the electrode body therein;

(3) a closure plate having a through hole in a central portion, the closure plate being secured at a peripheral portion to a rim of the opening of the external casing; and

(4) a valve member having a resilient portion and a plate portion, the plate portion being resiliently biased against the closure plate by the resilient portion to close off the hole. The closure plate is smaller in average thickness at a portion confronting a main surface of the plate portion than at another portion.

For purposes of description, hereinafter a “first portion” refers to a portion of the closure plate opposite the main surface of the plate portion. Similarly, a “second portion” refers to a portion of the closure plate other than the first portion. Generally, the first portion corresponds to the central portion of the closure plate, whereas the second portion corresponds to the peripheral portion surrounding the central portion.

With the above configuration, the sealed secondary battery according to the present invention is thinner at the first portion as compared with a conventional sealed secondary battery, while remaining comparable in thickness of the second portion. The second portion includes the portion that is secured to the opening of the external casing. Thus, as compared with a conventional sealed secondary battery, the sealed secondary battery according to the present invention provides the external casing having an increased space for accommodating an electrode body and thus allows an increase of the electrode body. This is achieved without affecting neither the outer dimensions of the battery nor the hermeticity of the battery, which may otherwise be caused in response to an increase of the internal pressure.

On the other hand, the first portion is not directly secured to the external casing. Thus, even if the first portion is thinner as compared with a conventional sealed secondary battery, no adverse effect is imposed on the hermeticity of the battery. Thus, the thickness of the first portion is reduced without affecting the hermeticity of the battery.

As described above, the sealed secondary battery according to the present invention has the first portion that is thinner than a conventional sealed secondary battery. This enables to accommodate an increased amount of electrode body, without reducing the length of the resilient portion in a steady state in the thickness direction of the closure plate.

The sealed secondary battery according to the present invention is not reduced in length of the resilient portion at a steady state in the thickness direction of the closure plate, as compared with a conventional sealed secondary battery. Thus, the sealed secondary battery according to the present invention ensures that the valve member operates as reliable as conventional arrangements.

That is to say, the sealed secondary battery according to the present invention allows that the electrode body to be increased in volume and thus incapacity. This is achieved without affecting neither the responsivity of the valve member to an increase in internal pressure of the battery nor the hermeticity of the battery even under an increased internal pressure.

The sealed secondary battery may further include a cap bonded to a main surface of the closure plate facing away from the external casing, in a manner to leave a space enclosed by the cap and the closure plate. The valve member is accommodated within the space and has a valve plate as the plate portion and a cone spring as the resilient portion. The cone spring is located between the cap and the valve plate so as to press the valve plate against the closure plate.

The closure plate may be centrally dished to have a recess toward the bottom of the external casing. The plate portion fits within the recess, so that a bottom of the recess is opposed to the main surface of the plate portion.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a cutaway side view of a closure assembly of a conventional nickel-cadmium battery;

FIG. 2 is an exploded perspective view of a nickel-cadmium battery according to an embodiment of the present invention;

FIG. 3 is a cutaway side view of a closure assembly of the nickel-cadmium battery according to the embodiment of the present invention;

FIG. 4A is a cutaway side view of a first variation of the closure assembly of the nickel-cadmium battery according to the embodiment of the present invention;

FIG. 4B is a cutaway side view of a second variation of the closure assembly of the nickel-cadmium battery according to the embodiment of the present invention;

FIG. 4C is a cutaway side view of a third variation of the closure assembly of the nickel-cadmium battery according to the embodiment of the present invention;

FIG. 5A is a cutaway side view of a closure assembly of a nickel-cadmium battery according to Comparative Example 1;

FIG. 5B is a cutaway side view of a closure assembly of a nickel-cadmium battery according to Comparative Example 2; and

FIG. 5C is a cutaway side view of a closure assembly of a nickel-cadmium battery according to Comparative Example 3.

### DESCRIPTION OF THE PREFERRED EMBODIMENT

The following describes an embodiment of the present invention, with reference to the accompanying drawings.

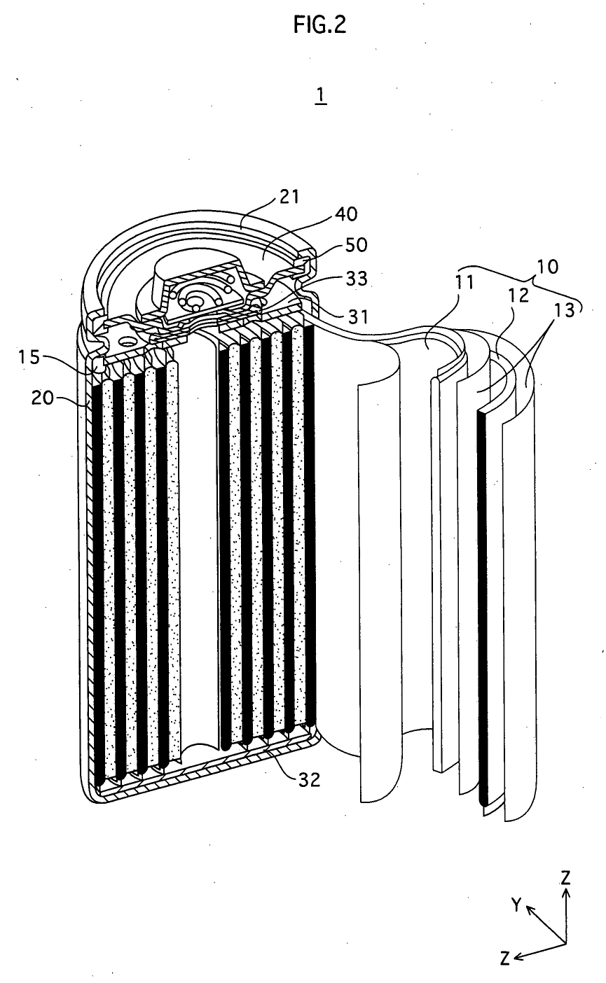

FIG. 2 is an exploded perspective view of a nickel-cadmium battery according to the embodiment.

As illustrated in FIG. 2, a nickel-cadmium battery 1 according to the embodiment includes an external casing 20 and an electrode body 10. The external casing 20 is a tubular member made of metal and having a bottom. The electrode body 10 is rolled and loaded into the external casing 20.

A pair of plate-like current collectors 31 and 32 are provided at each end of the rolled electrode body 10. The current collector 31, which is disposed at one end of the electrode body 10, has a tubular tab 33 in a state crushed between a closure assembly 40 and the current collector 31. The tab 33 is joined to the closure assembly 40 by, for example, resistance welding. It should be noted that the joining may be made by any scheme other than resistance welding. Examples of such joining schemes include laser radiation and electronic beam radiation. A ring-shaped spacer 15 is provided annularly between the outer rim of the current collector 31 and the inner surface of the external casing 20. With this structure, the current collector 31 is fixed in place and the external casing 20 is electrically insulated from the current collector 31. At the other end of the rolled electrode body 10, the current collector 32 is disposed. The main surface of the current collector 32 is in contact with the bottom of the external casing 20.

The electrode body 10 includes a positive plate 11, a negative plate 12, and a separator 13 each of which is sheet-like materials and wound together with the separator 13 sandwiched between the positive and negative plates 11 and 12. The positive plate 11 may be mainly composed of nickel oxide compound. The negative plate 12 is mainly composed of cadmium compound.

At the edge of the rolled electrode body 10 that is in contact with the current collector 31, the positive plate 11 extends beyond the negative plate 12. Thus, it is the positive plate 11 that is actually in contact with the current collector 31. On the other hand, at the other edge of the rolled electrode body 10 that is in contact with the current collector 32, the negative plate 12 extends beyond the edge of the positive plate 11. Thus, it is thus the negative plate 12 that is actually in contact with the current collector 32.

The closure assembly 40 is substantially shaped like a disc and sealed to an opening 21 of the external casing 20. An insulating gasket 50 is disposed annularly between the closure assembly 40 and the external casing 20. More specifically, the closure assembly 40 includes a closure plate 42, which will be described later, and the insulating gasket 50 is inserted annually between the closure plate 42 and the opening 21. Under this state, the opening 21 is swaged to fix the closure plate 42 relatively to the opening 21.

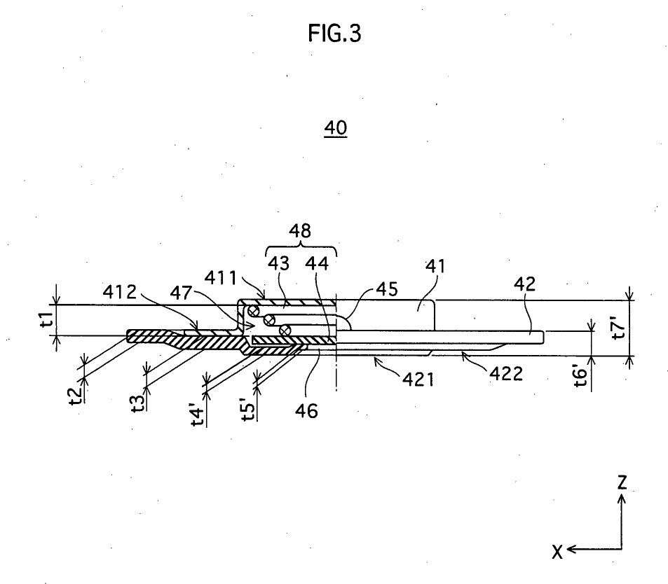

FIG. 3 is an exploded view showing the major part of the closure assembly 40 of the nickel-cadmium battery 1 according to the embodiment of the present invention.

As illustrated in FIG. 3, according to the embodiment of the present invention, the closure assembly 40 is generally composed of two plate-like members bonded together. In the state in which the closure assembly 40 is placed to close off the opening 21 of the external casing 20, the closure plate 42 is disposed on the side facing toward the external casing 20, whereas the cap 41 is disposed on the side facing away from the external casing 20.

Each of the closure plate 42 and the cap 41 is a dished plate. According to the embodiment of the present invention, the cap 41 is dished annularly toward the central portion to have two levels, whereas the closure plate 42 is dished annularly toward the central portion to have three levels.

The closure plate 42 and the cap 41 are placed with the respective recesses facing each other and joined together in a manner to leave a space 47 enclosed by the closure plate 42 and the cap 41. The space 47 accommodates a valve member 48 therein.

More specifically, the cap 41 is composed of a recess 411 and a flange 412. Similarly, the closure plate 42 is composed of a recess 421 and a flange 422. The cap 41 and the closure plate 42 are joined together by bonding the flanges 412 and 422 together.

The cap 41 has a first hole 45 formed through a side wall of the recess 411. The first hole 45 provides spatial communication between the space 47 and the exterior of the battery 1.

The closure plate 42 has a second hole 46 formed through the bottom of the recess 421. The second hole 46 provides spatial communication between the space 47 and the interior of the external casing 20.

According to the embodiment of the present invention, the valve member 48 is composed of a spiral spring 43 and a valve plate 44. The passage formed via the first hole 45 and the second hole 46 allows a gas flow.

The valve plate 44 fits within the recess 421 of the closure plate 42, and the main surface of the valve plate 44 confronts the bottom surface of the recess 421. This arrangement allows easy positioning of the valve plate 44 during assembly of the closure assembly 40, which serves to reduce the production time and improve the yield of the closure assembly 40. The spiral spring 43 is disposed such that one end thereof engages against the bottom surface of the recess 411 of the cap 41 and that the other end presses against the main surface of the valve plate 44. The valve plate 44 is spring-biased to close off the second hole 46, so that the gas passage is blocked

Yet, if the internal pressure of the external casing exceeds a predetermined value, the valve plate 44 is pressed back to compress the spring 43. As a result, the exterior and the interior of the external casing 20 are openly connected via the first hole 45 and the second hole 46 to provide communication through the gas passage.

As illustrated in FIG. 3, according to the embodiment of the present invention, the closure plate 42 is thinner at the bottom of the recess 421 located centrally thereof, as compared with other or peripheral portions. More specifically, Thicknesses t4′ and t5′ measured at annular portions nearer to the second hole 46 and confronting the valve plate 44 are smaller than Thicknesses t2 and t3 measured at the peripheral portions. With this arrangement, Thicknesses t4′ and t5′ of the annular portions confronting the valve plate 44 are made smaller as compared with conventional dimensions, while Thicknesses t2 and t3 of the peripheral portions are maintained comparable to conventional dimensions. That is, the closure plate 42 is reduced, as compared with conventional dimensions, in Distance t6′ between the main surface of the outermost peripheral portion of the flange 422 facing outwardly of the battery 1 and the bottom surface of the recess 421 facing inwardly of the battery 1. Further, according to the embodiment of the present invention, the closure assembly 40 is reduced in Thickness t7′ of its central portion, as compared with conventional dimensions. That is to say, while Distance t1 between the valve plate 44 and the bottom of the recess 411 of the cap 41 is maintained comparable to conventional dimensions, the distance between the bottom of the recess 421 of the closure plate 42 and the bottom of the external casing 20 is made longer as compared with conventional dimensions. It should be noted, in addition, that the thickness of the closure plate 42 according to the embodiment of the present invention is comparable to conventional dimensions, except for the recess 421. That is, the closure plate 42 is comparable to conventional dimensions in Thicknesses t2 and t3 measured at the flange 422.

Furthermore, the closure assembly 40 according to the embodiment of the present invention is comparable to a conventional closure assembly in Distance t1 between the valve plate 44 and the bottom of the recess 411 of the cap 41. Note that the central portion of the recess 421 of the closure plate 42 protrudes toward the positive direction along Z axis (toward the cap 41). With this configuration, the valve plate 44 is allowed to be placed on the protrusion. Thus, at the time of joining the tab 33 to the bottom of the recess 421, it is avoided that the valve plate 44 is unintentionally secured to the recess 421 by welding heat.

Effects of Sealed Secondary Battery According to Embodiment

As has been described, as compared with conventional sealed secondary batteries, a sealed secondary battery according to the embodiment of the present invention includes the closure assembly 40 that is smaller in Thickness t7 of the central portion thereof. This is achieved by reducing the closure plate 42 in Thicknesses t4′ and t5′ of the annular portion nearer the hole 46 and confronting the valve plate 44, while maintaining Thicknesses t2 and t3 of the flange 422 unchanged. Since the flange 422 of the closure plate 42 includes a portion where the closure plate 42 is actually fixed to the opening 21 of the external casing 20, the embodiment of the present invention ensures secure hermeticity of the battery. In addition, the external casing according to the embodiment of the present invention has an axially larger space for accommodating the electrode body 10 as compared with conventional dimensions. This is achieved without the need to change the length in the longitudinal direction (axial direction). Thus, the electrode body 10 is increased in size without affecting the outer dimensions of the battery 1.

According to the embodiment of the present invention, Distance t1 between the valve plate 44 and the inner bottom of the recess 411 of the cap 41 are the same as conventional dimensions. Thus, the spring 43 is ensured to have the stroke comparable to that of the conventional structure. Thus, it is ensured that the valve plate 44 works as reliably as a conventional structure in response to a rise in the internal pressure of the battery 1 to prevent any further rise. The embodiment of the present invention does not cause malfunction of the valve plate 44 and the spring 43.

As described above, the embodiment of the present invention allow the electrode body 10 to be increased in volume and thus in capacity, without involving any greater risk of a failure of the gas release mechanism or of the hermeticity as compared with a conventional structure.

According to this embodiment, in addition, the closure plate 42 has the second hole 46 that is formed though the bottom of the recess 421. That is, the second hole 46 is located apart from the external casing 20. With this structure, it is likely that the closure of the second hole 46 is broken if the bottom of the recess 421 deforms in response to an increased internal pressure. As a result, it is ensured that the closure assembly 40 remains undetached from the external casing, even if the internal pressure of the battery increases.

Supplemental Note

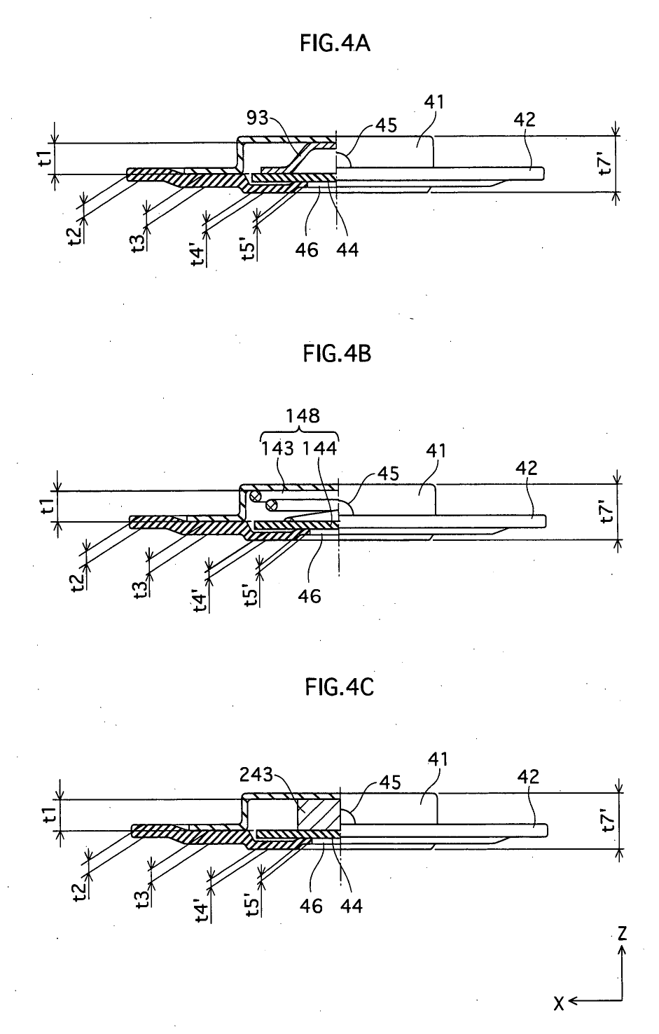

According to the above embodiment, the valve plate is normally biased to close off the hole by the spiral spring. Yet, the valve plate may be biased by any other means. FIGS. 4A-4C are cut-away side views showing first to third variations of the closure assembly according to the above embodiment the nickel-cadmium battery. For example, the valve plate 44 may be biased by a leaf spring 93 as illustrated in FIG. 4A. Alternatively, as illustrated in FIG. 4B, a valve member 148 may be composed of a spring 143 and a valve plate 144 that are integral with each other and the valve plate 144 may be biased by the spring 143. Alternatively, as illustrated in FIG. 4C, the valve plate 44 may be biased by a rubber member (elastic body) 243 of a flat cylindrical shape.

Still further, it is applicable that the valve plate may be biased by any other elastic body including a columnar resin.

According to the above embodiment, the closure assembly 40 is of a disc like outer shape but without limitation. For example, the closure assembly 40 may be of a rectangular outer shape. In addition, the outer shape of the external casing 20 is not limited to a cylindrical column and may be prismatic.

The above embodiment is directed to a nickel-cadmium battery but this is merely by way of an example. Without departing from the gist of the present invention, the present invention is applicable to other types of secondary batteries including a nickel-metal hydride battery.

According to the above embodiment, the external casing is described to be made of metal. However, it is applicable that the external casing may be made of other materials, such as resin.

Evaluation Tests

Evaluation tests were conducted in order to verify the effects of the sealed secondary battery according to the above embodiment.

Samples of nickel-cadmium battery (hereinafter, “NiCad battery”) of size SC (diameter: 22.0 mm and length: 42.5 mm) were prepared as Example 1 and Comparative Examples 1, 2, and 3. The capacity of each sample is 2400 mAh and the details are shown below.

Note that the samples differ from each other in the structure of the closure assembly. The external casing, the electrode body, and the closure-mechanism of the opening of the external casing are those known in the art. Thus, no further details thereof will be given here. Each closure assembly is made of a nickel-plated steel plate.

The samples of closure assemblies are all uniform in diametrical dimensions. More specifically, the main surface of each closure plate facing toward the external casing is recessed toward the center to have three levels. The outside diameter of the outermost annular portion measures 20.4 mm, the outside diameter of the intermediate annular portion measures 16 mm, and the outside diameter of the innermost annular portion measures 4.5 mm.

### Example 1

Each NiCad battery of Example 1 is identical in structure to the NiCad battery according to the above embodiment (See FIG. 3). The dimensions of the closure plate 42 areas follows. Thickness t2 of the flange 422 at the peripheral portion that is fixed to the external casing 20 measures 0.7 mm. Thicknesses t4′ and t5′ of the annular portions of the bottom of the recess 421 each measure 0.4 mm. Distance t1 between the valve plate 44 and the inner main surface of the recess 411, which is located at the center of the cap 41, measures 1.3 mm. Distance t1 corresponds to the length of the spring 43 in a state accommodated within the space 47. Thickness t7 of the central portion of the closure assembly 40 measures 2.9 mm.

### Comparative Example 1

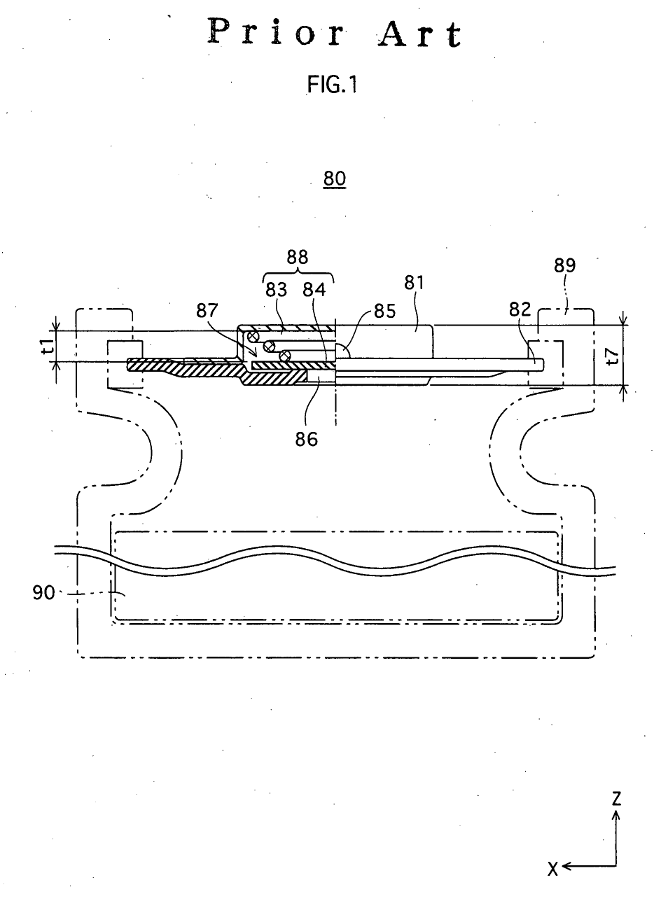

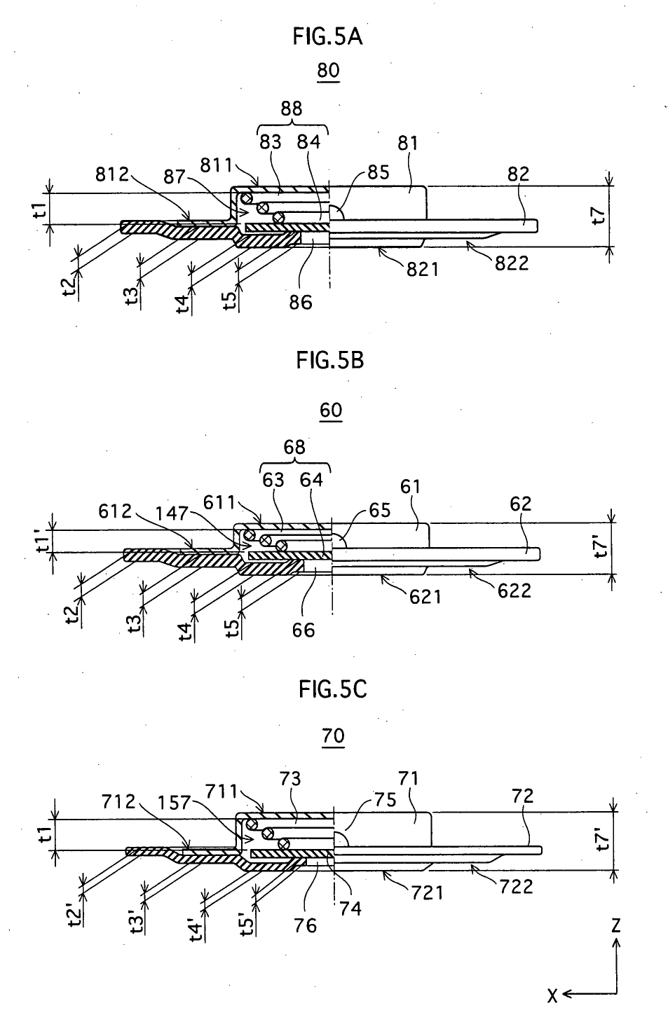

FIG. 5A is a cut-away side view showing the closure assembly of a NiCad battery according to Comparative Example 1. The NiCad battery according to Comparative Example 1 is identical in structure to a conventional NiCad battery (See FIG. 1). More specifically, as illustrated in FIG. 5A, the dimensions of the closure plate 82 is as follows. Thickness t2 of a flange 822 at the peripheral portion that is fixed to the external casing measures 0.7 mm. Thicknesses t4 and t5 of the annular portions of the bottom of the recess 821, which is located at the center of the closure plate 82, each measure 0.7 mm. Distance t1 between the valve plate 84 and the recess 811 disposed centrally of the cap 81 measures 1.3 mm. Distance to corresponds to the length of the spring 83 in a state accommodated within the space 87. Thickness t7 of the central portion of the closure assembly 80 measures 3.2 mm.

### Comparative Example 2

FIG. 5B is a cut-away side view showing the closure assembly of a NiCad battery according to Comparative Example 2. As compared with the conventional NiCad battery (illustrated in FIG. 5A), the NiCad battery of Comparative Example 2 is smaller in Thickness t7′ of the central portion of the closure assembly. More specifically, as illustrated in FIG. 5B, the dimensions of the closure plate 62 is as follows. Thickness t2 of a flange 622 at the peripheral portion that is fixed to the external casing measures 0.7 mm. Thicknesses t4 and t5 of the annular portions of the bottom of the recess 621, which is located at the center of the closure plate 62, each measure 0.7 mm. Distance t1′ between the valve plate 64 and the recess 611 disposed centrally of the cap 61 measures 1.0 mm. Distance t1′ corresponds to the length of the spring 63 in a state accommodated within the space 14. Thickness t7′ of the central portion of the closure assembly 60 measures 2.9 mm.

### Comparative Example 3

FIG. 5C is a cut-away side view showing the closure assembly of a NiCad battery according to Comparative Example 3. As compared with the conventional NiCad battery (illustrated in FIG. 5A), the NiCad battery of Example 3 is smaller in Thickness of the closure plate. More specifically, as illustrated in FIG. 5C, the dimensions of the closure plate 72 is as follows. Thickness t2′ of a flange 722 the peripheral portion fixed to the external casing measures 0.4 mm. Thicknesses t4′ and t5′ of the closure plate 72 at the bottom of a recess 721, which is located at the center of the closure plate 72, each measure 0.4 mm. Distance t1 between the valve plate 74 and the recess 711 disposed centrally of the cap 71 measures 1.3 mm. Thickness t7′ of the central portion of the closure assembly 70 measures 2.9 mm.

Details of Tests and Results

For each Example and Comparative Examples, 20 samples were prepared. Each sample was discharged before the tests. Each discharged sample was applied with a current of 40 A for thirty minutes to cause a forced discharge. The state of each sample is then checked. The results are shown in Table 1. Note that each thickness shown in Table 1 is an average of the 20 samples for each of Example and Comparative Examples.

TABLE 1

| | Comparative | Comparative | Comparative | |
|---|---|---|---|---|
| | Example 1 | Example 2 | Example 3 | Example 1 |
| Average Flange Thickness (mm) | t2, t3 = 0.7 | t2, t3 = 0.7 | t2′, t3′ = 0.4 | t2, t3 = 0.7 |
| Average Thickness of Closure | t4, t5 = 0.7 | t4, t5 = 0.7 | t4′, t5′ = 0.4 | t4′, t5′ = 0.4 |
| Plate Recessed Bottom (mm) | | | | |
| Length of Spring | t1 = 1.3 | t1′ = 1.0 | t1 = 1.3 | t1 = 1.3 |
| Accommodated in Space (mm) | | | | |
| Average Thickness of Closure | t7 = 3.2 | t7′ = 2.9 | t7′ = 2.9 | t7′ = 2.9 |
| Assembly Central Portion | | | | |
| Detachment Rate | 0% (0/20) | 20% (4/20) | 25% (5/20) | 0% (0/20) |

As shown in Table 1, regarding Example 1 and Comparative Example 1, the closure assemblies 40 and 80 remain closing the opening of the external casing. That is, Example 1 and Comparative Example 1 managed to maintain the hermeticity of the battery. Regarding Comparative Examples 2 and 3, on the other hand, the closure assemblies 60 and 70 were detached from the opening of the external casing. That is, Examples 2 and 3 failed to maintain the hermeticity of the battery.

Considerations Based on Test Results

Based on the test results, the reason that Comparative Example 2 failed to maintain the hermeticity is considered as follows. In a state where the spring 63 of the valve member 68 (gas release mechanism) is accommodated in the space 147 of the closure assembly 60, the length t1′ of the spring 63 is not long enough. That is, the stroke of the spring 63 is too small to provide allowance for the spring 63 to be sufficiently compressed by the valve plate 64. As a result, the battery failed to release gas caused to be generated by forced-discharge and the internal pressure of the battery increases to push the closure assembly 60 to detach it from the opening of the external casing.

Through a closer study of Comparative Example 3, deformation of the closure assembly 70 is noted. It is thus considered that the closure plate 72 of the closure assembly 70 is lower in strength as compared with a conventional configuration. It is because the thickness is reduced uniformly throughout the closure plate 72. As a result, the closure plate 72 deformed in response to a raise of the internal pressure and thus was disengaged from the opening of the external casing.

Regarding Example 1 and Comparative Example 1, it is considered that the length t1 of each of the springs 43 and 83 of the valve members 48 and 88 (gas release mechanisms) is long enough in the state being accommodated within the spaces 47 and 87 of the closure assemblies 40 and 80. That is, Example 1 and Comparative Example 1 ensure sufficient stroke of the springs 43 and 83 and sufficient strength of the closure plates 42 and 82 of the closure assemblies 40 and 80. Thus, Example 1 and Comparative Example 1 are capable of appropriately releasing gas generated within the battery by forced discharge. Consequently, deformation of the closure plates 42 and 82 was avoided, so that the closure assemblies 40 and 80 remain sealed to the opening of the external casing to maintain the hermeticity.

Especially to be noted is that Example 1 has a thinner closure assembly, and yet the closure assembly is comparable to a conventional closure assembly of NiCad battery in strength against internal pressure. This is achieved by reducing thickness t4′ and t5′, which is the thickness of the bottom of the recess 421, as compared with thickness t4 and t5 of Comparative Example 1. Yet, the thickness of the other portions remain unchanged.

As shown in Table 1, the closure plate 42 measures 0.4 mm in thicknesses t4′ and t5′ of the bottom of the recess 421, and 0.7 mm in thicknesses t2 and t3 of the peripheral portions of the closure plate 42. The test results show that the closure plate is sufficient in strength as long as thicknesses t4′ and t5′ each measure at least 58% of thicknesses t2 and t3. Yet, it goes without saying that thicknesses t4′ and t5′ should be less than 100% of thicknesses t2 and t3. It is because if thicknesses t4′ and t5′ are each equal to t2 and t3, such a closure assembly does not achieve an object of the present invention.

### INDUSTRIAL APPLICABILITY

The present invention is applicable to a sealed battery having an external casing within a predetermined spec and improves the energy density of such a battery. The present invention is especially useful in applications where the battery is required to ensure a certain level of mechanical strength. As such, the present invention is extremely usable in to a number of applications.

What is claimed is:

1. A sealed secondary battery comprising:
an electrode body having a positive plate, a negative plate, and a separator;
an external casing of a tubular shape having a bottom and an opening, the external casing accommodating the electrode body therein;
a closure plate having a through hole in a central portion, the closure plate being secured at a peripheral portion to a rim of the opening of the external casing; and
a valve member having a resilient portion and a plate portion, the plate portion being resiliently biased against the closure plate by the resilient portion to close off the hole,
wherein the closure plate is smaller in average thickness at a portion opposite a main surface of the plate portion than at another portion.

2. The sealed secondary battery according to claim 1, further comprising:
a cap bonded to a main surface of the closure plate facing away from the external casing, in a manner to leave a space enclosed by the cap and the closure plate,
wherein the valve member is accommodated within the space and has a valve plate as the plate portion and a cone spring as the resilient portion, and the cone spring is located between the cap and the valve plate so as to press the valve plate against the closure plate.

3. The sealed secondary battery according to claim 1,
wherein the closure plate is centrally dished to have a recess toward the bottom of the external casing, and
wherein the plate portion fits within the recess, so that a bottom of the recess is opposed to the main surface of the plate portion.
